(19) United States
(12) Patent Application Publication
(10) Pub. No.: US 2025/0229989 A1
(43) Pub. Date: Jul. 17, 2025

(54) ARTICLE MANAGEMENT SYSTEM, INFORMATION PROCESSING DEVICE AND INFORMATION PROCESSING METHOD

(71) Applicant: KABUSHIKI KAISHA TOSHIBA, Tokyo (JP)

(72) Inventors: Toshikazu TAKI, Tokyo (JP); Ryutaro YAMAGUCHI, Ichikawa (JP); Tsubasa KUSAKA, Yokohama (JP)

(21) Appl. No.: 19/020,838

(22) Filed: Jan. 14, 2025

(30) Foreign Application Priority Data
Jan. 16, 2024 (JP) 2024-004868

(51) Int. Cl. B65G 1/137; G06K 7/14

(52) U.S. Cl. CPC B65G 1/1371; G06K 7/1417; B65G 2203/0216; B65G 2203/041; B65G 2203/046

(57) ABSTRACT

An article management system includes a camera, a container, a rack, a storage part, and a controller. The camera images a prescribed space. The container stores an article as a management object. The rack is located inside the space. The rack stores the container. The storage part stores article identification information, container identification information, and rack identification information. The rack includes an identification code being identifiable by the camera. The storage part stores a first association and a second association. The first association is of rack identification information or container identification information, and container identification information. The second association is of the rack identification information or the container identification information, and article identification information. The controller detects a position of the article inside the space based on imaging data and the first and second associations.

### CROSS-REFERENCE TO RELATED APPLICATIONS

This application is based upon and claims the benefit of priority from Japanese Patent Application No. 2024-004868, filed on Jan. 16, 2024; the entire contents of which are incorporated herein by reference.

### FIELD

Embodiments described herein relate generally to an article management system, an information processing device, and an information processing method.

### BACKGROUND

To manage articles in a plant, a warehouse, or the like, a known article management system uses identifiers to manage the states of the articles. Technology of such an article management system that can more easily manage the positions of the articles is desirable.

### BRIEF DESCRIPTION OF THE DRAWINGS

FIG. 1 is a block diagram showing a functional configuration of a management system 100 according to an embodiment;

FIG. 2 is a schematic plan view of a space S;

FIG. 3 shows a data structure of a rack database 16 stored in a storage part 15;

FIG. 4 shows a data structure of a container database 17 stored in the storage part 15;

FIG. 5 shows a data structure of an article database 18 stored in the storage part 15;

FIG. 6 shows management hierarchical data R;

FIG. 7 is a flowchart showing the overall flow of processing according to the management system 100;

FIG. 8 is a flowchart showing the processing flow of an article receiving process (S100);

FIG. 9 is a flowchart showing the processing flow of an article storing process (S200);

FIG. 10 is a flowchart showing the processing flow of a container storing process (S300);

FIG. 11 is a flowchart showing the processing flow of a container transfer process (S400);

FIG. 12 is a flowchart showing the processing flow of an article mounting process (S500);

FIG. 13 is a schematic perspective view of a workbench 80;

FIG. 14 shows a search screen 84 for searching for the storage position of an article 70; and

FIG. 15 is a block diagram showing a hardware configuration of an information processing device.

### DETAILED DESCRIPTION

In general, according to one embodiment, an article management system includes a camera, a container, a rack, a storage part, and a controller. The camera is configured to image a space. The space is prescribed. The container is configured to store an article. The article being a management object. The rack is located inside the space. The rack is configured to store the container. The storage part is configured to store article identification information, container identification information, and rack identification information as identification information to respectively and uniquely identify the article, the container, and the rack. The rack includes an identification code. The identification code is identifiable by the camera. The storage part stores a first association and a second association. The first association is of rack identification information assigned to the rack or container identification information assigned to the container, and container identification information assigned to another container stored at the rack or in the container. The second association is of the rack identification information assigned to the rack or the container identification information assigned to the container, and article identification information assigned to the article stored at the rack or in the container. The controller detects a position of the article inside the space based on imaging data and the first and second associations. The imaging data is imaged by the camera.

### 1. Embodiments

Exemplary embodiments will now be described with reference to the drawings. In the specification of the application and the drawings, components similar to those described in regard to a drawing thereinabove are marked with like reference numerals, and a detailed description is omitted as appropriate.

### 1.1 Functional Configuration of Management System 100

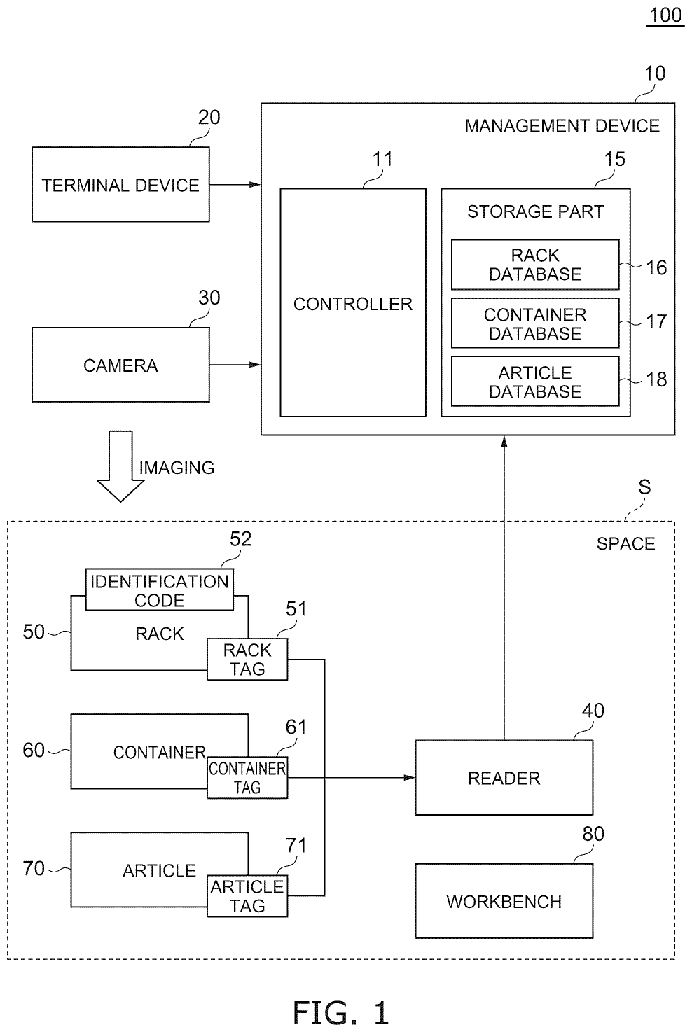

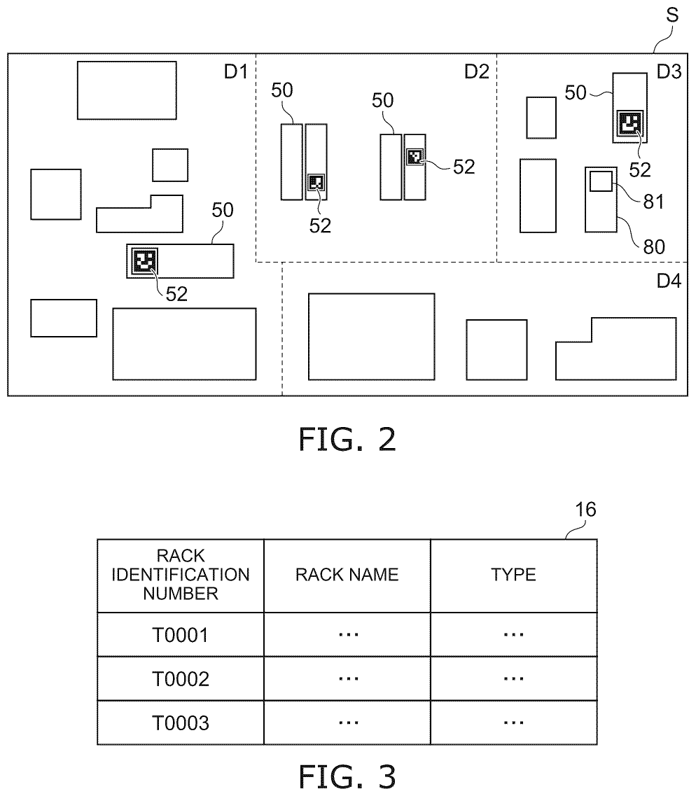

A functional configuration of a management system 100 according to an embodiment will now be described with reference to FIGS. 1 and 2. As shown in FIG. 1, the management system 100 includes a management device 10, a terminal device 20, and a camera 30 that images a space S.

As an example, the management device 10 is an information processing device (a computer) that functions as a server and manages data related to articles. The management device 10 includes a controller 11 and the storage part 15. The controller 11 controls the processing of the management device 10 as a processor. The storage part 15 stores programs and data necessary for the processing of the controller 11, data obtained by the processing of the controller 11, etc. As an example, the storage part 15 stores the rack database 16, the container database 17, and the article database 18. Details of the databases are described below.

The terminal device 20 is an information processing device that includes an input part and an output part and can be operated by a worker. The terminal device 20 may be a general-purpose or special-purpose personal computer smart device, etc. Smart devices include tablet terminals, smartphones, smart glasses, smartwatches, etc.

The camera 30 images the space S. The imaging data that is imaged by the camera 30 may be still images or may be a video image. When the imaging data is still images, the specifications of the camera 30 may be such that the imaging data is generated by imaging at a prescribed timing (e.g., at 1 minute intervals). The specifications may be such that the imaging data imaged by the camera 30 is stored in the storage part 15 every prescribed period. Favorably, the management system 100 includes multiple cameras 30 that overlook the space S.

As an example, the space S may be a prescribed region in a plant. In the example shown in FIG. 2, the space S is subdivided into multiple regions D1 to D4; and one or multiple racks 50 are located in each region. The rack 50 stores a container 60. The rack 50 also stores the article 70. The rack 50 includes a rack tag 51 and an identification code 52.

The rack tag 51 and the identification code 52 are mounted to the rack 50 and include identification information for uniquely identifying the rack 50. The rack tag 51 and the identification code 52 may be realized using at least one of a one-dimensional barcode, a two-dimensional barcode, a radio frequency identifier (RFID), or an integrated circuit (IC). As an example, the identification code 52 is mounted to the upper surface of the rack 50 to be identifiable by the camera 30. In other words, the identification code 52 includes identification information that is identifiable as image information. On the other hand, the identification information of the rack tag 51 is read by a reader 40, which is described below; it is therefore not always necessary for the rack tag 51 to be identifiable as image information. For example, the rack tag 51 may be realized using a RFID; and the identification code 52 may be realized using a two-dimensional barcode.

The container 60 stores the article 70. The container 60 also may store other containers 60. In other words, the container 60 includes a primary container stored in the rack 50, and a (n+1)-ary container stored in an n-ary container, wherein n is a natural number. The container 60 includes a container tag 61.

The container tag 61 is mounted to the container 60 and includes identification information for uniquely identifying the container 60. The container tag 61 may be realized using at least one of a one-dimensional barcode, a two-dimensional barcode, a radio frequency identifier (RFID), or an integrated circuit (IC). As an example, the container tag 61 may be realized using a RFID.

The article 70 is a tangible object to be managed; and examples of the article 70 include a part used to assemble a product in a plant, etc. The article 70 is stored in the container 60. The article 70 may be directly stored at the rack 50 without being stored in the container 60. The article 70 includes an article tag 71.

The article tag 71 is mounted to the article 70 and includes identification information for uniquely identifying the article 70. The article tag 71 may be realized using at least one of a one-dimensional barcode, a two-dimensional barcode, a radio frequency identifier (RFID), or an integrated circuit (IC). As an example, the article tag 71 may be realized using a RFID.

The reader 40 reads rack identification information, container identification information, or article identification information respectively from the rack tag 51, the container tag 61, or the article tag 71 (hereinbelow, generally referred to as simply tags). When the rack tag 51, the container tag 61, and the article tag 71 are barcodes, the reader 40 is a barcode reader. When the rack tag 51, the container tag 61, and the article tag 71 are RFID tags, the reader 40 is a RFID reader. When the rack tag 51, the container tag 61, and the article tag 71 are IC tags, the reader 40 is an IC reader. Thus, by the rack tag 51, the container tag 61, and the article tag 71 including the same type of data, the rack tag 51, the container tag 61, and the article tag 71 can be read using a common reader 40. The reader 40 transmits the data that is read to the management device 10.

The reader 40 may be a handheld type that can be carried by an operator that utilizes the management system 100 to perform a task related to the article 70 (hereinbelow, also called simply the operator), may be a gate type that is provided at the prescribed location inside the space S and reads tags passing through a location, or may be a combination of these two.

The workbench 80 is used when using the article 70 to perform a prescribed task such as assembling a product, etc. Details of the workbench 80 are described below.

The terminal device 20, the camera 30, and the reader 40 are connected with the management device 10 via wired communication, wireless communication, or a network, and are configured to communicate data with the management device 10.

### 1.2 Data Structure

An example of a data structure of a database stored in the storage part 15 will now be described with reference to FIGS. 3 to 6. As an example, the storage part 15 may store the rack database 16, the container database 17, and the article database 18.

The rack database 16 is a database for storing information of the rack 50. As an example, the rack database 16 may include the item “rack identification number”, the item “rack name”, and the item “type”.

The item “rack identification number” is identifier data for uniquely identifying the records of the rack database 16, and functions as the primary key of the rack database 16. The records of the rack database 16 correspond to the racks 50 inside the space S. The specifications of each rack 50 inside the space S may be such that each rack 50 includes the rack tag 51 and the identification code 52 corresponding to the item “rack identification number”. As an example, each rack 50 may include a RFID tag including the item “rack identification number” as the rack tag 51, and may include a two-dimensional code corresponding to the item “rack identification number” as the identification code 52.

The item “rack name” is information related to the name of the rack 50 corresponding to the record. The operator can appropriately set the name of the rack 50 corresponding to each record of the rack database 16.

The item “type” is information related to the type of the rack 50 corresponding to the record. As an example, the operator can appropriately set the type based on the dimensions, the type based on the shape, the type based on the application, etc., for each rack 50.

The records of the rack database 16 can be appropriately added and modified by the operator. For example, the operator can operate the terminal device 20 to add a record to the rack database 16 at the timing at which the rack 50 is added inside the space S.

The container database 17 is a database for storing information of the container 60. As an example, the container database 17 may include the item “container identification number”, the item “container name”, the item “type”, the item “storage container”, and the item “storage rack”.

The item “container identification number” is identifier data for uniquely identifying the records of the container database 17, and functions as the primary key of the container database 17. The records of the container database 17 correspond to the containers 60 stored at the rack 50 inside the space S. The specifications of each container 60 inside the space S may be such that each container 60 includes the container tag 61 corresponding to the item “container identification number”. As an example, the containers 60 may include a RFID tag including the item “container identification number” as the container tag 61.

The item “container name” is information related to the name of the container 60 corresponding to the record. The operator can appropriately set the name of the container 60 corresponding to each record of the container database 17.

The item “type” is information related to the type of the container 60 corresponding to the record. As an example, the operator can appropriately set the type based on the dimensions, the type based on the shape, the type based on the application, etc., for each container 60.

The item “storage container” is information related to the container 60 in which the container 60 corresponding to the record is stored. As an example, the item “container identification number” of the container 60 in which the container 60 is stored is set to the item “storage container”.

The item “storage rack” is information related to the rack 50 at which the container 60 corresponding to the record is stored. As an example, the item “rack identification number” of the rack 50 at which the container 60 is stored is set to the item “storage rack”. In such a case, the item “storage rack” may function as an external key. According to the embodiment, data is input to one of the item “storage container” or the item “storage rack”.

The records of the container database 17 can be appropriately added and modified by the operator. For example, the operator can operate the terminal device 20 to add a record to the container database 17 at the timing at which the container 60 is added inside the space S. Also, the operator can operate the terminal device 20 to modify the item “storage rack” of the container database 17 at the timing at which the rack 50 at which the container 60 is stored is modified.

The article database 18 is a database for storing information of the article 70. As an example, the article database 18 may include the item “article identification number”, the item “article name”, the item “task status”, the item “storage container”, and the item “storage rack”.

The item “article identification number” is identifier data for uniquely identifying the records of the article database 18, and functions as the primary key of the article database 18. Each record of the article database 18 corresponds to the article 70 stored in the container 60 stored at the rack 50 inside the space S or the article 70 stored at the rack 50 inside the space S. The specifications of each article 70 inside the space S may be such that each article 70 includes the article tag 71 corresponding to the item “article identification number”. As an example, each article 70 may include a RFID tag including the item “article identification number” as the article tag 71.

The item “article name” is information related to the name of the article 70 corresponding to the record. The operator can appropriately set the name of the article 70 corresponding to each record of the article database 18.

The item “task status” is information of the status related to a prescribed task related to the article 70 corresponding to the record. As an example, the operator can appropriately set information such as “awaiting task”, “task completed”, etc.

The item “storage container” is information related to the container 60 in which the article 70 corresponding to the record is stored. As an example, the operator may set the item “container identification number” of the container 60 in which the article 70 is stored as the item “storage container”. In such a case, the item “storage rack” may function as an external key.

The item “storage rack” is information related to the rack 50 at which the article 70 corresponding to the record is stored. As an example, the operator may set the item “rack identification number” of the rack 50 at which the article 70 is stored as the item “storage rack”. In such a case, the item “storage rack” may function as an external key. According to the embodiment, data is input to one of the item “storage container” or the item “storage rack”.

Each record of the article database 18 can be appropriately added and modified by the operator. For example, the operator can operate the terminal device 20 to add a record to the article database 18 at the timing at which a new article 70 is stored in the container 60 stored at the rack 50 inside the space S. Also, the operator can operate the terminal device 20 to modify the item “storage container” of the article database 18 at the timing at which the container 60 in which the article 70 is stored is modified.

Thus, the storage part 15 stores: a first association of rack identification information assigned to the rack 50 or container identification information assigned to the container 60, and container identification information assigned to another container 60 stored at the rack 50 or in the container 60; and a second association of the rack identification information assigned to the rack 50 or the container identification information assigned to the container 60, and article identification information assigned to the article 70 stored at the rack 50 or in the container 60. The database described above is merely an example and is not limited to such a configuration. In other words, the storage part 15 may include other databases; or, the rack database 16, the container database 17, and the article database 18 may include other items.

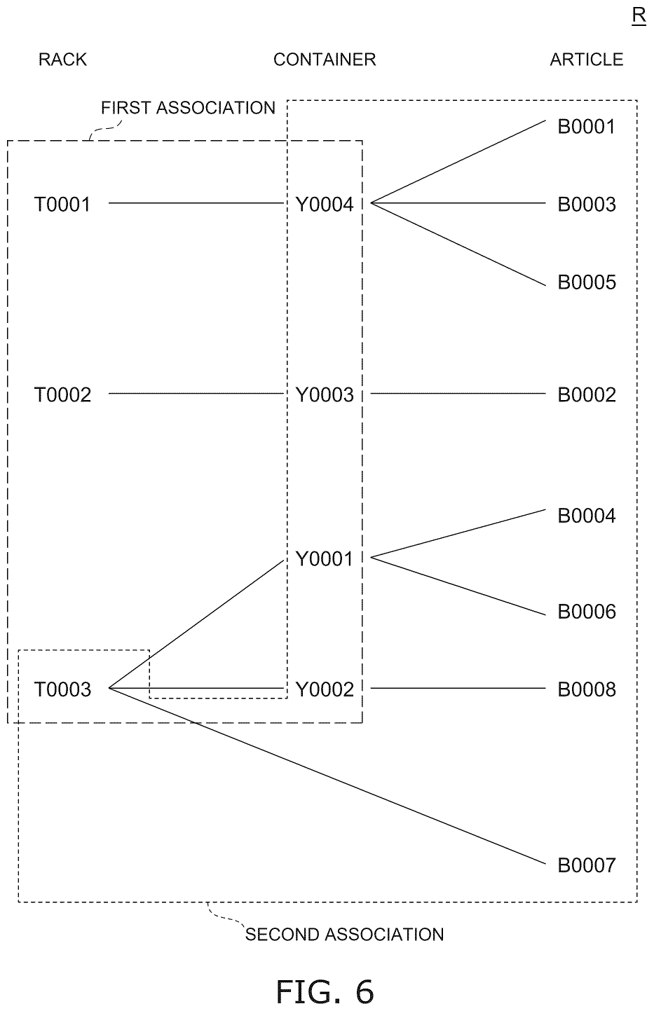

The management hierarchical data R that is generated by the controller 11 will now be described with reference to FIG. 6. The controller 11 generates the management hierarchical data R based on the rack database 16, the container database 17, and the article database 18.

As shown in FIG. 6, the management hierarchical data R is data having a tree structure that is based on the rack database 16, the container database 17, and the article database 18 and includes: the first association of rack identification information assigned to the rack 50 or container identification information assigned to the container 60, and container identification information assigned to another container 60 stored at the rack 50 or in the container 60; and the second association of the rack identification information assigned to the rack 50 or the container identification information assigned to the container 60, and article identification information assigned to the article 70 stored at the rack 50 or in the container 60.

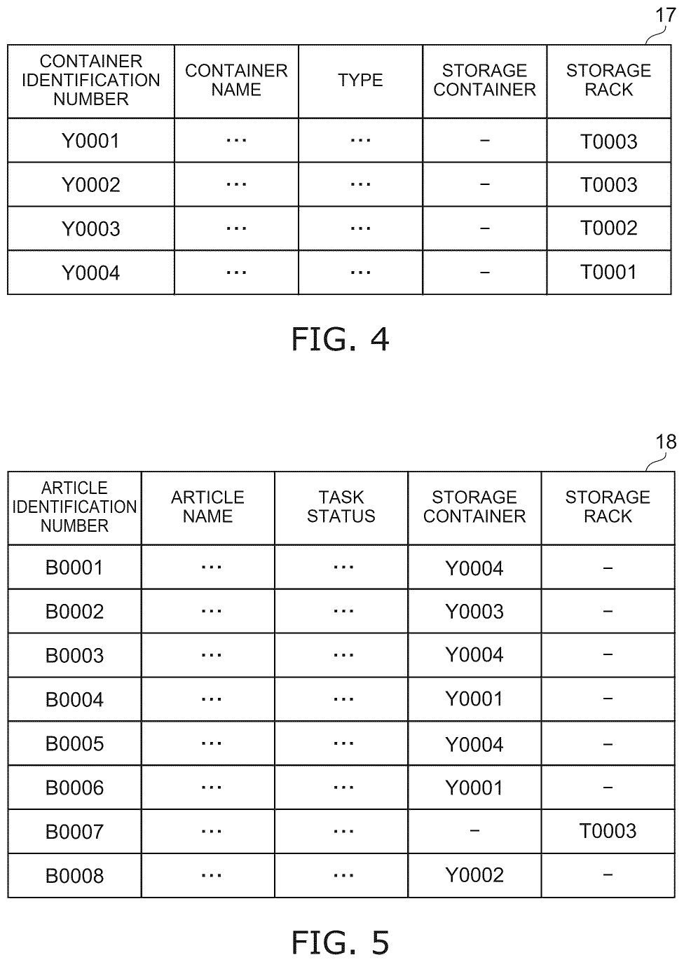

As an example, the management hierarchical data R shown in FIG. 6 shows that a container Y0004 is stored at a rack T0001, and an article B0001, an article B0003, and an article B0005 are stored in the container Y0004. On the other hand, referring to the article database 18 of FIG. 5, the records that correspond to the articles B0001, B0003, and B0005 have Y0004 as an external key in the item “storage container”. Furthermore, referring to the container database 17 of FIG. 4, the record that corresponds to the container Y0004 has T0001 as an external key in the item “storage rack”.

As another example, the management hierarchical data R shown in FIG. 6 shows that a container Y0001 and a container Y0002 are stored at a rack T0003; and an article B0007 also is stored at the rack T0003. Also, an article B0004 and an article B0006 are stored in the container Y0001; and an article B0008 is stored in the container Y0002.

On the other hand, referring to the article database 18 of FIG. 5, the records that correspond to the articles B0004 and B0006 have Y0001 as an external key in the item “storage container”. The record that corresponds to the article B0008 has Y0002 as an external key in the item “storage container”. The record that corresponds to the article B0007 has T0003 as an external key in the item “storage rack”. Referring to the container database 17 of FIG. 4, the records that correspond to the containers Y0001 and Y0002 have T0003 as an external key in the item “storage rack”. Thus, the data that is stored in the management hierarchical data R matches the data stored in the rack database 16, the container database 17, and the article database 18.

Generally, the controller 11 uses the rack identification information assigned to the rack 50 as a reference to generate the management hierarchical data R so that the container identification information assigned to the container 60 used as a primary container stored at the rack 50 or the article identification information assigned to the article 70 stored at the rack 50 is located in a lower level. Furthermore, the controller 11 generates the management hierarchical data R so that the container identification information assigned to the container 60 used as a secondary container stored in the container 60 used as the primary container to which the container identification information located in the lower level is assigned or the article identification information assigned to the article 70 stored in the container 60 used as the primary container is located in an even lower level.

The depth of the levels of the management hierarchical data R is appropriately set according to the storage configuration of the container 60 and the storage configuration of the article 70. For example, when the container 60 is stored at the rack 50 and the article 70 is stored in the container 60 as in the rack T0001 shown in FIG. 6, the management hierarchical data R has a depth of two lower levels. On the other hand, when the article 70 is stored directly at the rack 50 as in the rack T0003 shown in FIG. 6, the management hierarchical data R has a depth of one lower level. As described above, the container 60 may store another container 60, and so the containers 60 having small volumes can be sequentially stored in the containers 60 having large volumes. For example, the management hierarchical data R has a depth of four lower levels when the container 60 is stored at the rack 50, two containers 60 are sequentially stored in that container 60, and the article 70 is stored in the innermost container 60. The management hierarchical data R is presented to the operator as appropriate based on an operation of the terminal device 20 by the operator. As a result, the operator can easily ascertain the first and second associations related to the rack 50, the container 60, and the article 70.

### 1.3 Processing Flow

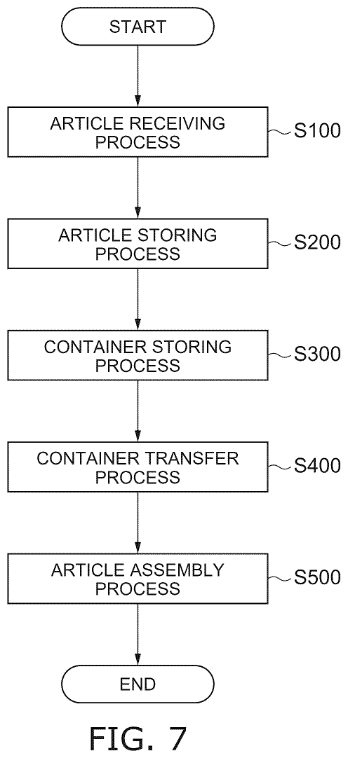

An example of the processing flow of the management system 100 will now be described with reference to FIGS. 7 to 13.

As shown in FIG. 7, the management system 100 may perform an article receiving process (S100), an article storing process (S200), a container storing process (S300), a container transfer process (S400), and an article assembly process (S500). The processes will now be described in detail. The processes are performed inside the space S; and the rack 50 is located inside the space S. As an example, the rack 50 stores multiple containers 60 that store multiple articles 70.

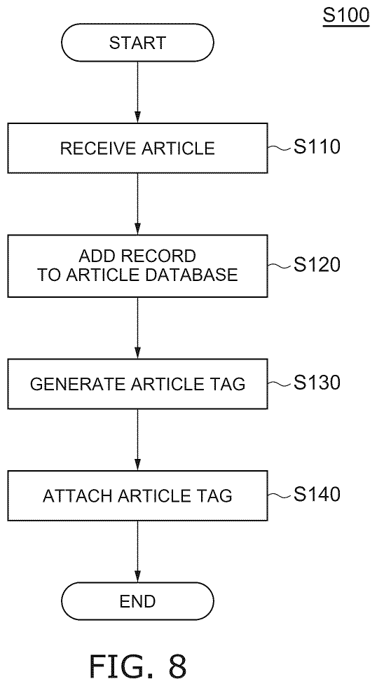

The processing flow of the article receiving process (S100) will now be described with reference to FIG. 8. The article receiving process (S100) is performed at the timing at which the article 70 that is a management object is newly received. In step S110, the operator newly receives the article 70 that is a management object. In step S120, the operator operates the terminal device 20 to add a record corresponding to the article 70 in the article database 18 of the storage part 15.

In step S130, the operator operates the terminal device 20 to generate the article tag 71 on which the article identification information of the article 70 (as an example, the item “article identification number” of the article database 18) is written. In step S140, the operator attaches the generated article tag 71 to the article.

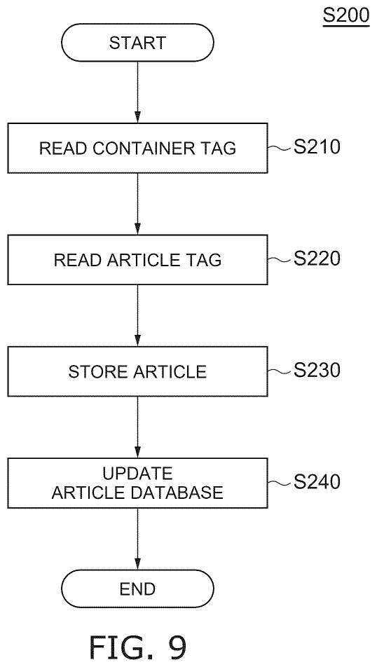

The processing flow of the article storing process (S200) will now be described with reference to FIG. 9. The article storing process (S200) is performed at the timing at which the article 70 is stored in the container 60. In step S210, the operator uses, for example, the handheld type reader 40 to read the container tag 61 attached to the container 60 in which the article 70 is stored. The container identification information of the container tag 61 that is read is transmitted to the management device 10. In step S220, the operator uses, for example, the handheld type reader 40 to read the article tag 71 attached to the article 70. The container identification information of the article tag 71 that is read is transmitted to the management device 10.

In step S230, the operator stores the article 70 in the container 60. In step S240, the controller 11 of the management device 10 updates the article database 18 in the storage part 15 based on an operation of the terminal device 20 by the operator. Specifically, the controller 11 updates the item “storage container” of the record corresponding to the article 70 of the article database 18.

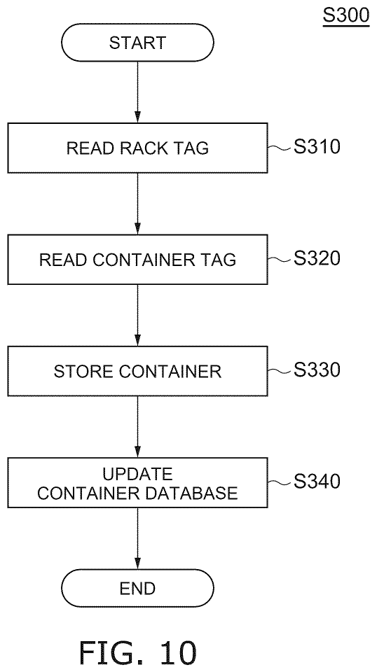

The processing flow of the container storing process (S300) will now be described with reference to FIG. 10. The container storing process (S300) is performed at the timing at which the container 60 is stored at the rack 50. In step S310, the operator uses, for example, the handheld type reader 40 to read the rack tag 51 attached to the rack 50 at which the container 60 is stored. The rack identification information of the rack tag 51 that is read is transmitted to the management device 10. In step S320, the operator uses, for example, the handheld type reader 40 to read the container tag 61 attached to the container 60. The container identification information of the container tag 61 that is read is transmitted to the management device 10.

In step S330, the operator stores the container 60 at the rack 50. In step S340, the controller 11 of the management device 10 updates the container database 17 in the storage part 15 based on an operation of the terminal device 20 by the operator. Specifically, the controller 11 updates the item “storage rack” of the record corresponding to the container 60 of the container database 17.

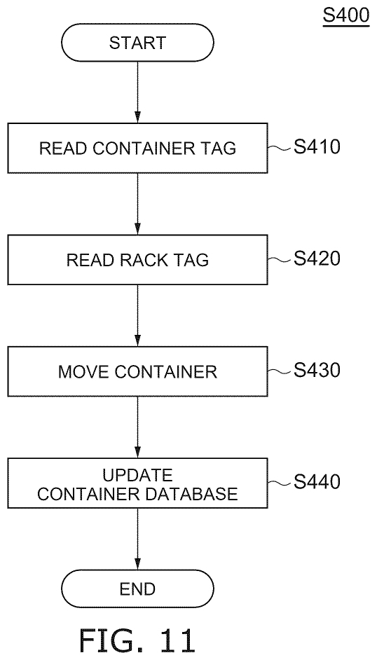

The processing flow of the container transfer process (S400) will now be described with reference to FIG. 11. The container transfer process (S400) is performed at the timing at which the container 60 that is stored at a specific rack 50 is moved to another rack 50. In step S410, the operator uses, for example, the handheld type reader 40 to read the container tag 61 attached to the container 60 to be moved to another rack. The container identification information of the container tag 61 that is read is transmitted to the management device 10. In step S420, the operator uses, for example, the handheld type reader 40 to read the rack tag 51 attached to the rack 50 at which the container 60 will be newly stored. The rack identification information of the rack tag 51 that is read is transmitted to the management device 10.

In step S430, the operator moves the container 60 and stores the container 60 at the new rack 50. In step S440, the controller 11 of the management device 10 updates the container database 17 in the storage part 15 based on an operation of the terminal device 20 by the operator. Specifically, the controller 11 updates the item “storage rack” of the record corresponding to the container 60 of the container database 17.

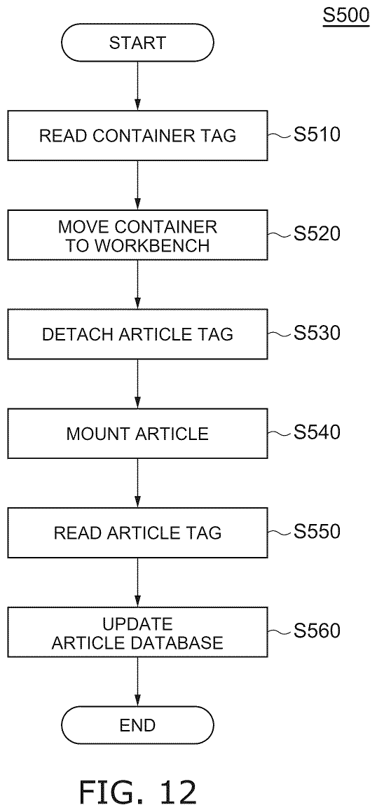

The processing flow of the article mounting process (S500) will now be described with reference to FIG. 12. The article mounting process (S500) is performed at the timing at which the article 70 stored in the container 60 is used in a task of mounting to a product. In step S510, the operator uses, for example, the handheld type reader 40 to read the container tag 61 attached to the container 60 in which the article 70 used in the mounting task is stored. The container identification information of the container tag 61 that is read is transmitted to the management device 10. In step S520, the operator moves the container 60 to the workbench 80.

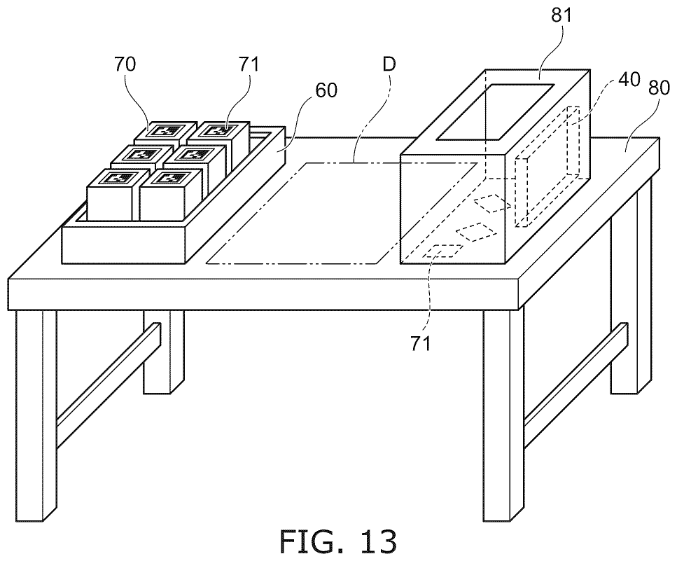

FIG. 13 shows an example of the workbench 80. As shown in FIG. 13, the workbench 80 includes a tag container 81 and a workspace D. The tag container 81 receives the article tag 71 attached to the article 70 after the prescribed task related to the article (according to the embodiment, the task of mounting to the product) is completed. The tag container 81 includes the reader 40. The article identification information of the article tag 71 received inside the tag container 81 is read by the reader 40 and transmitted to the management device 10. Thus, the controller 11 of the management device 10 can detect information related to the article 70 based on the article identification information included in the article tag 71 inside the tag container 81.

In step S530, the operator detaches the article tag 71 attached to the article 70 and receives the article tag 71 inside the tag container 81. In step S540, the operator mounts the article 70 to the product. In step S550, the reader 40 inside the tag container 81 reads the article identification information of the article tag 71 that is received. The article identification information of the article tag 71 that is read is transmitted to the management device 10.

In step S560, the controller 11 of the management device 10 updates the article database 18 in the storage part 15 based on an operation of the terminal device 20 by the operator. Specifically, the controller 11 deletes the data of the item “storage container” of the record corresponding to the article 70 of the article database 18. Or, the specifications of the controller 11 may be such that the entire record corresponding to the article 70 is deleted (e.g., a logical deletion). As a result, the article identification information that is included in the article tag 71 inside the tag container 81 also is deleted from the management hierarchical data R.

Based on the article identification information included in the article tag 71 inside the tag container 81, the controller 11 also can detect the progress of the mounting task as information related to the article 70. Specifically, information related to the mounting task of the article corresponding to the record is prestored in the item “task status” of the article database 18. In other words, when the mounting task of the article is completed and the article tag 71 is received inside the tag container 81, the controller 11 updates the item “task status” of the record corresponding to the article 70 of the article database 18 based on an operation of the terminal device 20 by the operator. By such specifications, the operator can easily ascertain the progress of the task related to the article 70.

### 1.4 Screen Example

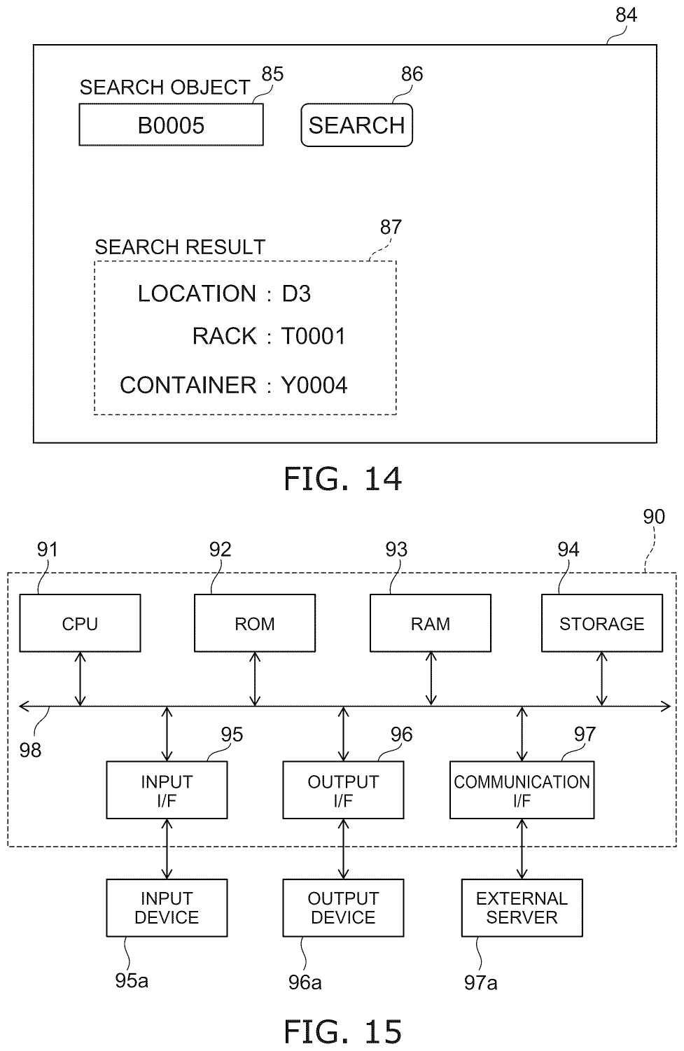

The search screen 84 used by the operator to search for the position of the article 70 will now be described with reference to FIG. 14. In the processes described above, the operator can search for the position at which a desired article 70 is stored by operating the search screen 84 displayed in the display included in the terminal device 20.

As shown in FIG. 14, the search screen 84 includes a search object input field 85, a search button 86, and a search result display region 87. The operator inputs the article identification number of the desired article 70 in the search object input field 85 and presses the search button 86. The operator may input the article name of the desired article 70 in the search object input field 85.

The controller 11 responds to the operator pressing the search button 86 by detecting the position of the article 70 inside the space S based on the imaging data imaged by the camera 30 and the first and second associations stored in the rack database 16, the container database 17, and the article database 18, which are stored in the storage part 15.

Specifically, the controller 11 refers to the article database 18 and acquires the record that has the article identification number input to the search object input field 85 in the item “article identification number”. The controller 11 acquires the item “storage container” and the item “storage rack” of the record that is acquired.

When there is data in the item “storage container” of the record acquired from the article database 18, the controller 11 refers to the container database 17 to acquire the record having data matching the item “storage container” in the item “container identification number”. The controller 11 acquires the item “storage container” and the item “storage rack” of the record that is acquired. When there is data in the item “storage container”, the controller 11 again refers to the container database 17, acquires a record having data matching the item “storage container” in the item “container identification number”, and repeats until a record having data in the item “storage rack” is acquired. On the other hand, when there is data in the item “storage rack”, the controller 11 refers to the rack database 16 and acquires a record having data matching the item “storage rack” in the item “rack identification number”.

On the other hand, when there is data in the item “storage rack” of the record acquired from the article database 18, the controller 11 refers to the rack database 16 and acquires a record having data matching the item “storage rack” in the item “rack identification number”.

Based on the imaging data imaged by the camera 30, the controller 11 detects the position of the rack 50 corresponding to the record acquired from the rack database 16. Specifically, the controller 11 identifies the identification codes 52 included in the racks 50 inside the space S based on the imaging data imaged by the camera 30, and based on the imaging data, determines the position of the rack 50 including the identification code 52 that matches the item “rack identification number” included in the record acquired from the rack database 16.

Thus, the controller 11 detects the information of the position of the article 70 that is the search object accepted from the user. The controller 11 presents, to the user, the position of the article that is the search object accepted from the user based on the information of the detected position of the article by displaying the position of the article in the search result display region 87 of the search screen 84. As an example as shown in FIG. 14, the search result display region 87 of the search screen 84 displays the information of the container 60 in which the article that is the search object is stored, the rack 50 at which the container 60 is stored, and the location inside the space S at which the rack 50 is located. By such a configuration, the operator that will use the article 70 to perform a task can easily and rapidly ascertain the position of the desired article 70.

### 1.5 Hardware Configuration

A hardware configuration of an information processing device included in the management device 10 will now be described with reference to FIG. 15. For example, the terminal device 20 and the management device 10 used as the information processing device are realized by a computer 90 shown in FIG. 15. The computer 90 includes a CPU 91, ROM 92, RAM 93, storage 94, an input interface 95, an output interface 96, and a communication interface 97.

The CPU 91 functions as a processor that performs processing. Specifically, the CPU 91 uses the RAM 93 as work memory to execute the programs stored in at least one of the ROM 92 or the storage 94. When executing the programs, the CPU 91 executes various processing by controlling configurations via a system bus 98.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The storage 94 stores data necessary for executing the programs and/or data obtained by executing the programs. The storage 94 includes at least one selected from a hard disk drive (HDD) and a solid state drive (SSD).

The input interface (I/F) 95 can connect the computer 90 and an input device 95a. The input interface 95 is, for example, a serial bus interface such as USB, etc. The CPU 91 can read various data from the input device 95a via the input interface 95.

The output interface (I/F) 96 can connect the computer 90 and an output device 96a. The output interface 96 is, for example, an image output interface such as Digital Visual Interface (DVI), High-Definition Multimedia Interface (HPMI (registered trademark)), etc. The CPU 91 can transmit data to the output device 96a via the output interface 96 and can cause the output device 96a to output the data.

The input device 95a includes at least one selected from a mouse, a keyboard, a microphone (audio input), and a touchpad. The output device 96a includes at least one selected from a display, a projector, a printer, and a speaker. A device such as a touch panel that functions as both the input device 95a and the output device 96a may be used.

The communication interface (I/F) 97 can connect the computer 90 and an external server 97a outside the computer 90. The communication interface 97 is, for example, a network card such as a LAN card, etc. The CPU 91 can read various data from the external server 97a via the communication interface 97.

The processing that is performed by the management device 10 may be realized by one computer 90, or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a processor to execute the instructions recited in the program based on the program. In the computer, the acquisition (or the reading) of the program may be performed via a network.

### 1.6 Summary

Thus, the management system 100 according to the embodiment includes: the camera 30 that images the prescribed space S; the container 60 in which the article 70 that is the management object is stored; the rack 50 located inside the space S, and at which the container 60 is stored; the storage part 15 storing the article identification information, the container identification information, and the rack identification information as the identification information for respectively and uniquely identifying the article 70, the container 60, and the rack 50; and the controller 11. The rack 50 includes the identification code 52 that is identifiable by the camera 30. The storage part 15 stores: the first association of rack identification information assigned to the rack 50 or container identification information assigned to the container 60, and container identification information assigned to another container 60 stored at the rack 50 or in the container 60; and the second association of the rack identification information assigned to the rack 50 or the container identification information assigned to the container 60, and article identification information assigned to the article 70 stored at the rack 50 or in the container 60. The controller 11 detects the position of the article 70 inside the space S based on the imaging data imaged by the camera 30 and the first and second associations. By such a configuration, the position of the article 70 that is the management object can be managed more easily. The article tag 71 that includes the article identification information may be attached to the article 70; the container tag 61 that includes the container identification information may be attached to the container 60; and the rack tag 51 that includes the rack identification information may be attached to the rack 50. The specifications of the management system 100 may be such that the management system 100 further includes a reader that reads the article identification information, the container identification information, or the rack identification information from the article tag 71, the container tag 61, or the rack tag 51. By using such specifications, the identification information for uniquely identifying the article 70, the container 60, and the rack 50 can be easily read from the article 70, the container 60, and the rack 50.

The management system 100 also may include the tag container 81 that receives the article tag 71 attached to the article 70 after the prescribed task related to the article 70 is completed. The reader 40 is located in the tag container 81; and the specifications of the controller 11 of the management device 10 may be such that the controller 11 detects information related to the article 70 based on the article identification information included in the article tag 71 inside the tag container 81. By using such a configuration, the operator can easily detect information related to the article 70 used in a prescribed task.

The technical idea of the disclosure is applicable even for a combination of a configuration in which the article 70 is stored in the container 60 and the container 60 is stored at the rack 50 and a configuration in which the article 70 is stored directly at the rack 50 without using the container 60.

### 2. Other Embodiments

Although the management system 100 according to the embodiment is described above, applications of the technical idea of the disclosure are not limited to the embodiments above. For example, although a case is described in the embodiment above where a handheld type reader 40 that can be carried by the operator is utilized in the container transfer process (S400), a gate type reader 40 may be used. In such a case, by locating the gate type reader 40 between different racks 50, the movement of the container 60 can be read by the gate type reader 40 without the operator performing the reading task with the handheld type reader 40. The technical idea of the disclosure is applicable for such specifications as well.

Although the space S is assumed to be one continuous region according to the embodiment above, the space S is not limited to such a configuration. For example, one or multiple cameras 30 may be installed in each of a space S1, a space S2, . . . , and a space Sn over multiple floors; and the space S1, the space S2, . . . , and the space Sn collectively may be the space S.

Although the article that is the management object is assumed to be a part inside a plant according to the embodiment above, the article that is the management object is not limited to such an example. For example, the technical idea of the disclosure is applicable to the inventory management of merchandise in a retail store such as a convenience store, etc.

Embodiments include the following aspects.

### Note 1

An article management system, comprising:
a camera configured to image a space, the space being prescribed;
a container configured to store an article, the article being a management object;
a rack located inside the space, the rack being configured to store the container;
a storage part configured to store article identification information, container identification information, and rack identification information as identification information to respectively and uniquely identify the article, the container, and the rack; and
a controller,
the rack including an identification code,
the identification code being identifiable by the camera,
the storage part storing
   a first association of
      rack identification information assigned to the rack or container identification information assigned to the container, and container identification information assigned to another container stored at the rack or in the container, and
   a second association of
      the rack identification information assigned to the rack or the container identification information assigned to the container, and article identification information assigned to the article stored at the rack or in the container,
the controller detecting a position of the article inside the space based on imaging data and the first and second associations,
the imaging data being imaged by the camera.

### Note 2

The system according to note 1, further comprising:
an article tag attached to the article, the article tag including the article identification information;
a container tag attached to the container, the container tag including the container identification information;
a rack tag attached to the rack, the rack tag including the rack identification information; and
a reader configured to read the article identification information, the container identification information, or the rack identification information from the article tag, the container tag, or the rack tag.

### Note 3

The system according to note 1 or 2, wherein
the container includes a primary container stored at the rack, and a (n+1)-ary container stored in an n-ary container, n being a natural number,
the controller generates management hierarchical data by using the rack identification information assigned to the rack as a reference,
container identification information assigned to the primary container stored at the rack is located in a lower level of the management hierarchical data, or article identification information assigned to the article stored at the rack is located in the lower level of the management hierarchical data,
container identification information assigned to a secondary container stored in the primary container to which the container identification information located in the lower level is assigned is located in an even lower level of the management hierarchical data, or article identification information assigned to the article stored in the primary container to which the container identification information located in the lower level is assigned is located in the even lower level of the management hierarchical data, and
a depth of levels of the management hierarchical data is arbitrarily settable.

### Note 4

The system according to note 2, further comprising:
a tag container configured to receive the article tag attached to the article after completing a prescribed task related to the article,
the reader being located at the tag container,
the controller detecting information related to the article based on the article identification information included in the article tag inside the tag container.

### Note 5

The system according to note 4, wherein
the controller deletes, from the management hierarchical data, the article identification information included in the article tag inside the tag container.

### Note 6

The system according to note 4, wherein
the controller detects a status related to the prescribed task as the information related to the article based on the article identification information included in the article tag inside the tag container.

### Note 7

The system according to any one of notes 2 and 4-6, wherein
at least one of the article tag, the container tag, or the rack tag is implemented using a RFID or a barcode, and
the reader includes at least one of a handheld type or a gate type.

### Note 8

The system according to any one of notes 1-7, wherein
based on information of the detected position of the article, the controller presents a position of an article to be searched, the article to be searched being accepted from a user.

### Note 9

The system according to any one of notes 1-8, wherein a plurality of the cameras overlooks the space.

### Note 10

An information processing device, comprising:
a storage part configured to store article identification information, container identification information, and rack identification information as identification information to respectively and uniquely identify an article, a container configured to store the article, and a rack configured to store the container, the article being a management object; and
a controller,
the rack being located inside a space, the space being prescribed,
the rack including an identification code,
the identification code being identifiable by a camera imaging the prescribed space,
the storage part storing
   a first association of
      rack identification information assigned to the rack or container identification information assigned to the container, and container identification information assigned to another container stored at the rack or in the container, and
   a second association of
      the rack identification information assigned to the rack or the container identification information assigned to the container, and article identification information assigned to the article stored at the rack or in the container,
the controller detecting a position of the article inside the space based on imaging data and the first and second associations,
the imaging data being imaged by the camera.

### Note 11

A program,
when executed by an information processing device, the program causing the information processing device to perform processing,
the information processing device including:
   a storage part configured to store article identification information, container identification information, and rack identification information as identification information to respectively and uniquely identify an article, a container configured to store the article, and a rack configured to store the container, the article being a management object; and
   a controller,
the rack being located inside a space, the space being prescribed,
the rack including an identification code,
the identification code being identifiable by a camera imaging the prescribed space,
the storage part being caused to store:
   a first association of
      rack identification information assigned to the rack or container identification information assigned to the container, and container identification information assigned to another container stored at the rack or in the container; and
   a second association of
      the rack identification information assigned to the rack or the container identification information assigned to the container, and article identification information assigned to the article stored at the rack or in the container,
the controller being caused to:
   identify the identification code based on imaging data imaged by the camera;
   acquire the first and second associations from the storage part;
   detect a position of the article inside the space based on the imaging data and the first and second associations; and
   cause a display of the information processing device to display the detected position of the article.

### Note 12

An information processing method causing an information processing device to perform processing,
the information processing device including:
   a storage part configured to store article identification information, container identification information, and rack identification information as identification information to respectively and uniquely identify an article, a container configured to store the article, and a rack configured to store the container, the article being a management object; and
   a controller,
the rack being located inside a space, the space being prescribed,
the rack including an identification code,
the identification code being identifiable by a camera imaging the prescribed space,
the method comprising:
   causing the storage part to store
      a first association of
         rack identification information assigned to the rack or container identification information assigned to the container, and container identification information assigned to another container stored at the rack or in the container, and
      a second association of
         the rack identification information assigned to the rack or the container identification information assigned to the container, and article identification information assigned to the article stored at the rack or in the container; and
   causing the controller to detect a position of the article inside the space based on imaging data and the first and second associations, the imaging data being imaged by the camera.

### Note 13

An article management system, comprising:
a camera configured to image a space, the space being prescribed;
a rack located inside the space, the rack being configured to store an article, the article being a management object;
a storage part configured to store article identification information and rack identification information as identification information to respectively and uniquely identify the article and the rack; and
a controller,
the rack including an identification code,
the identification code being identifiable by the camera,
the storage part storing an association of
   rack identification information assigned to the rack, and
   article identification information assigned to the article stored at the rack,
the controller detecting a position of the article inside the space based on imaging data and the association,
the imaging data being imaged by the camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

What is claimed is:

1. An article management system, comprising:
a camera configured to image a space, the space being prescribed;
a container configured to store an article, the article being a management object;
a rack located inside the space, the rack being configured to store the container;
a storage part configured to store article identification information, container identification information, and rack identification information as identification information to respectively and uniquely identify the article, the container, and
the rack; and
a controller,
the rack including an identification code,
the identification code being identifiable by the camera,
the storage part storing
a first association of
rack identification information assigned to the rack or container identification information assigned to the container, and container identification information assigned to another container stored at the rack or in the container, and
a second association of
the rack identification information assigned to the rack or the container identification information assigned to the container, and article identification information assigned to the article stored at the rack or in the container,
the controller detecting a position of the article inside the space based on imaging data and the first and second associations,
the imaging data being imaged by the camera.

2. The system according to claim 1, further comprising:
an article tag attached to the article, the article tag including the article identification information;
a container tag attached to the container, the container tag including the container identification information;
a rack tag attached to the rack, the rack tag including the rack identification information; and
a reader configured to read the article identification information, the container identification information, or the rack identification information from the article tag, the container tag, or the rack tag.

3. The system according to claim 2, wherein
the container includes a primary container stored at the rack, and a (n+1)-ary container stored in an n-ary container, n being a natural number,
the controller generates management hierarchical data by using the rack identification information assigned to the rack as a reference,
container identification information assigned to the primary container stored at the rack is located in a lower level of the management hierarchical data, or article identification information assigned to the article stored at the rack is located in the lower level of the management hierarchical data,
container identification information assigned to a secondary container stored in the primary container to which the container identification information located in the lower level is assigned is located in an even lower level of the management hierarchical data, or article identification information assigned to the article stored in the primary container to which the container identification information located in the lower level is assigned is located in the even lower level of the management hierarchical data, and
a depth of levels of the management hierarchical data is arbitrarily settable.

4. The system according to claim 3, further comprising:
a tag container configured to receive the article tag attached to the article after completing a prescribed task related to the article,
the reader being located at the tag container,
the controller detecting information related to the article based on the article identification information included in the article tag inside the tag container.

5. The system according to claim 4, wherein
the controller deletes, from the management hierarchical data, the article identification information included in the article tag inside the tag container.

6. The system according to claim 4, wherein
the controller detects a status related to the prescribed task as the information related to the article based on the article identification information included in the article tag inside the tag container.

7. The system according to claim 2, wherein
at least one of the article tag, the container tag, or the rack tag is implemented using a RFID or a barcode, and
the reader includes at least one of a handheld type or a gate type.

8. The system according to claim 1, wherein
based on information of the detected position of the article, the controller presents a position of an article to be searched, the article to be searched being accepted from a user.

9. The system according to claim 1, wherein
a plurality of the cameras overlooks the space.

10. An information processing device, comprising:
a storage part configured to store article identification information, container identification information, and rack identification information as identification information to respectively and uniquely identify an article, a container configured to store the article, and a rack configured to store the container, the article being a management object; and
a controller,
the rack being located inside a space, the space being prescribed,
the rack including an identification code,
the identification code being identifiable by a camera imaging the prescribed space,
the storage part storing
a first association of
rack identification information assigned to the rack or container identification information assigned to the container, and container identification information assigned to another container stored at the rack or in the container, and
a second association of
the rack identification information assigned to the rack or the container identification information assigned to the container, and article identification information assigned to the article stored at the rack or in the container,
the controller detecting a position of the article inside the space based on imaging data and the first and second associations,
the imaging data being imaged by the camera.

11. An information processing method causing an information processing device to perform processing,
the information processing device including:
a storage part configured to store article identification information, container identification information, and rack identification information as identification information to respectively and uniquely identify an article, a container configured to store the article, and a rack configured to store the container, the article being a management object; and
a controller,
the rack being located inside a space, the space being prescribed,
the rack including an identification code,
the identification code being identifiable by a camera imaging the prescribed space,
the method comprising:
causing the storage part to store
a first association of
rack identification information assigned to the rack or container identification information assigned to the container, and container identification information assigned to another container stored at the rack or in the container, and
a second association of
the rack identification information assigned to the rack or the container identification information assigned to the container, and article identification information assigned to the article stored at the rack or in the container; and
causing the controller to detect a position of the article inside the space based on imaging data and the first and second associations, the imaging data being imaged by the camera.

12. An article management system, comprising:
a camera configured to image a space, the space being prescribed;
a rack located inside the space, the rack being configured to store an article, the article being a management object;
a storage part configured to store article identification information and rack identification information as identification information to respectively and uniquely identify the article and the rack; and
a controller,
the rack including an identification code,
the identification code being identifiable by the camera,
the storage part storing an association of
rack identification information assigned to the rack, and
article identification information assigned to the article stored at the rack,
the controller detecting a position of the article inside the space based on imaging data and the association,
the imaging data being imaged by the camera.
